(19) United States
(12) Patent Application Publication
(10) Pub. No.: US 2020/0189463 A1
(43) Pub. Date: Jun. 18, 2020

(54) DETECTING PUDDLES AND STANDING WATER

(71) Applicant: Waymo LLC, Mountain View, CA (US)

(72) Inventors: Clayton Kunz, Mill Valley, CA (US); David Harrison Silver, San Carlos, CA (US); Christian Lauterbach, Campbell, CA (US); Roshni Cooper, Cupertino, CA (US)

(21) Appl. No.: 16/218,926

(22) Filed: Dec. 13, 2018

(51) Int. Cl. B60R 1/00; G01S 17/89; G01S 17/42; B60W 40/06

(52) U.S. Cl. CPC B60R 1/00; G01S 17/89; G01S 17/936; B60W 40/06; G01S 17/42

(57) ABSTRACT

The technology relates detecting standing water. In one example, a system comprising one or more processors may be configured to receive sensor data generated by a perception system of a vehicle, wherein the sensor data corresponds to an area surrounding a vehicle. The one or more processors may identify a location in the area where the sensor data is not present and receive map information corresponding to the area, wherein the map information includes road surface locations. The one or more processors may determine that the location corresponds to one or more of the road surface locations in the map information; and output, based upon the determination that the location corresponds to one or more of the road surface locations in the map information, an indication that standing water is at the location.

### BACKGROUND

Autonomous vehicles, such as vehicles which do not require a human driver when operating in an autonomous driving mode, may be used to aid in the transport of passengers or items from one location to another. An important component of an autonomous vehicle is the perception system, which allows the vehicle to perceive and interpret its surroundings using sensors such as cameras, radar, LIDAR sensors, and other similar devices. For instance, the perception system and/or the vehicle's computing devices may process data from these sensors in order to identify objects as well as their characteristics such as location, shape, size, orientation, heading, acceleration or deceleration, type, etc. This information is critical to allowing the vehicle's computing systems to make appropriate driving decisions for the vehicle.

### BRIEF SUMMARY

Aspects of the disclosure provide a method for detecting standing water. The method may include receiving, by one or more processors, sensor data generated by a perception system of a vehicle, wherein the sensor data corresponds to an area surrounding a vehicle; identifying, by the one or more processors, a location in the area where the sensor data does not meet a threshold amount of data; receiving, by the one or more processors, map information corresponding to the area, wherein the map information includes road surface locations; determining, by the one or more processors, that the location corresponds to one or more of the road surface locations in the map information; and outputting, by the one or more processors, based upon the determination that the location corresponds to one or more of the road surface locations in the map information, an indication that standing water is at the location.

In some instances, the sensor data may be generated by a LIDAR sensor.

In some instances, identifying the location in the area where the sensor data does not meet the threshold amount may include determining the amount of sensor data in the area is below the threshold amount.

The method may include identifying a starting point and an end point of the standing water, wherein the starting point and end point correspond to locations where received signals are reflected back from an area immediately around the standing water, and the starting point is a point nearest to the vehicle and end point is located at an opposite side of the standing water. In some examples, the method may include determining a length of the standing water, wherein the length is determined by calculating the distance between the starting point and end point.

The method may include identifying a pair of points on opposite sides of the standing water, wherein the pair of points correspond to locations where received signals are reflected back from an area immediately around the standing water. In some examples, the method may include determining a width of the standing water, wherein the width is determined by calculating the distance between the pair of points. In some examples, the method may include determining, based on the map information, a lowest elevation point of the road surface at the location; determining the elevation of the starting point or ending point; and determining a depth of the standing water by calculating a distance between the lowest elevation point and the elevation of either the starting or the end point.

The method may include adjusting the operation of the vehicle based on the indication that standing water is at the location.

The method may include determining a confidence value of the indication that standing water is at the location; and adjusting the operation of the vehicle upon the confidence value satisfying a threshold value.

The method may include capturing a camera image, including image data, of the area surrounding a vehicle, and inputting the image into a model to identify the location of the standing water. In some examples, upon identifying the location of the standing water by the model, increasing a confidence value, and adjusting the operation of the vehicle upon the confidence value satisfying a threshold value.

Another aspect of the disclosure provides a system for detecting standing water. The system may comprise one or more processors, wherein the one or more processors are configured to: receive sensor data generated by a perception system of a vehicle, wherein the sensor data corresponds to an area surrounding a vehicle; identify a location in the area where the sensor data is not present; receive map information corresponding to the area, wherein the map information includes road surface locations; determine that the location corresponds to one or more of the road surface locations in the map information; and output, based upon the determination that the location corresponds to one or more of the road surface locations in the map information, an indication that standing water is at the location.

In some instances, the system may include the vehicle.

The sensor data may be generated by a LIDAR sensor of the perception system.

The one or more processors may be configured to identify a starting point and an end point of the standing water, wherein the starting point and end point correspond to locations where received signals are reflected back from an area immediately around the standing water; and the starting point and end point are located on opposite sides of the standing water. In some examples, the one or more processors may be configured to determine the length of the standing water, wherein the length is determined by calculating the distance between the starting point and end point.

The one or more processors may be configured to identify a pair of points on opposite sides of the standing water, wherein the pair of points correspond to locations where received signals are reflected back from an area immediately around the standing water. In some instances, the one or more processors may be configured to determine the width of the standing water, wherein the width is determined by calculating the distance between the pair of points.

### BRIEF DESCRIPTION OF THE DRAWINGS

FIG. 1 is a functional diagram of an example vehicle in accordance with an exemplary embodiment.

FIG. 2 is an example of map information in accordance with aspects of the disclosure.

FIG. 3 is an example external view of a vehicle in accordance with aspects of the disclosure.

FIG. 4A is an example illustration of sensor signals directed towards standing water at a location in accordance with aspects of the disclosure.

FIG. 4B is an example illustration of sensor signals directed towards and reflected off of a location in accordance with aspects of the disclosure.

FIG. 5A is an example illustration of sensor signals directed towards and reflected off of standing water in accordance with aspects of the disclosure.

FIG. 5B is an example illustration of a sensor's determination of a path travelled by signals transmitted and received by the sensor in accordance with aspects of the disclosure.

FIGS. 6A and 6B are example illustrations of radar sensor signal in accordance with aspects of the disclosure.

FIGS. 7A and 7B are example illustrations of sensor signals directed towards and around standing water in accordance with aspects of the disclosure.

FIGS. 8A and 8B are examples of determining the dimensions of standing water in accordance with aspects of the disclosure.

FIG. 9 is a flow diagram in accordance with aspects of the disclosure.

FIG. 10 is a flow diagram in accordance with aspects of the disclosure.

### DETAILED DESCRIPTION

### Overview

The technology relates to detecting standing water, such as puddles. Vehicles are regularly operated in situations where puddles and other such pools of water are present (collectively, “standing water”). Human drivers can alter the way the vehicles traverse through the standing water, such as by slowing down the vehicle to avoid losing traction with the road surface. In some instances, human drivers may determine the water is too deep to traverse and may maneuver the vehicle around or away from the standing water to avoid having the vehicle lose traction with the road surface and/or having the vehicle stall out in the standing water. Autonomous vehicles, which do not have same ability to reason about standing water as humans, must be able to detect standing water in order to safely transport cargo and/or passengers. In this regard, absent the ability to detect standing water, autonomous vehicles may fail to alter their operating parameters (e.g., velocity, trajectory, etc.,) upon encountering standing water. As such, autonomous vehicles may traverse through the standing water, which may result in the vehicle losing traction with the road surface (i.e., hydroplaning) or, in some instances, stalling out in the standing water.

To address these issues, an autonomous vehicle may detect standing water in real time and determine an appropriate action to take in response to detecting standing water. For instance, one or more sensors on an autonomous vehicle may capture sensor data corresponding to areas in the vehicle's vicinity. The sensor data may be analyzed by one or more computing devices of the autonomous vehicle and standing water may be detected. In some instances, characteristics of the standing water, such as its depth, length, width, etc., may also be determined. A machine learning model may be used to assist in determining the presence of standing water in the vehicle's vicinity. Depending on the detection and characteristics of the standing water, a determination as to whether an action should be performed by the vehicle may be made.

The features described herein may allow an autonomous vehicle to detect and respond to standing water in real time. By doing such, autonomous vehicles may be able to operate in areas which are prone to flooding. Moreover, the autonomous vehicles may be able to adjust their behavior to safely reach their destinations. Additionally, when a pick up or drop off location of the vehicle is determined to be in, or near standing water, the autonomous vehicle may alter its pick up or drop off location away from the standing water.

In addition, water splashed from standing water may be detected as an object by the vehicle's sensors, which may cause the vehicle to abruptly slow down, swerve, or perform some other action. By detecting standing water before the water is splashed, the autonomous vehicle may take appropriate actions prior to the water being splashed, such as slowing down or altering its trajectory. Moreover, the autonomous vehicle may be able to anticipate the actions of other vehicles on the road as they approach or traverse the standing water, thereby allowing the autonomous vehicle to take appropriate responsive actions. Additionally, the autonomous vehicle may alter its behavior to avoid splashing the standing water to avoid splashing other vehicles and/or pedestrians.

### Example Systems

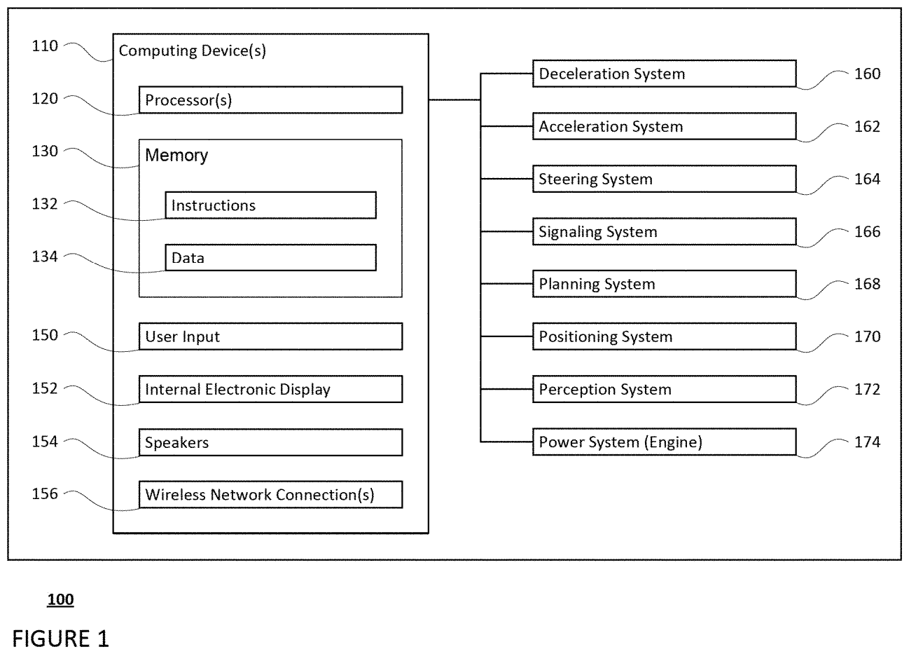

As shown in FIG. 1, a vehicle 100 in accordance with one aspect of the disclosure includes various components. While certain aspects of the disclosure are particularly useful in connection with specific types of vehicles, the vehicle may be any type of vehicle including, but not limited to, cars, trucks, motorcycles, buses, recreational vehicles, etc. The vehicle may have one or more computing devices, such as computing device 110 containing one or more processors 120, memory 130 and other components typically present in general purpose computing devices.

The memory 130 stores information accessible by the one or more processors 120, including instructions 134 and data 132 that may be executed or otherwise used by the processor 120. The memory 130 may be of any type capable of storing information accessible by the processor, including a computing device-readable medium, or other medium that stores data that may be read with the aid of an electronic device, such as a hard-drive, memory card, ROM, RAM, DVD or other optical disks, as well as other write-capable and read-only memories. Systems and methods may include different combinations of the foregoing, whereby different portions of the instructions and data are stored on different types of media.

The instructions 134 may be any set of instructions to be executed directly (such as machine code) or indirectly (such as scripts) by the processor. For example, the instructions may be stored as computing device code on the computing device-readable medium. In that regard, the terms “instructions” and “programs” may be used interchangeably herein. The instructions may be stored in object code format for direct processing by the processor, or in any other computing device language including scripts or collections of independent source code modules that are interpreted on demand or compiled in advance. Functions, methods and routines of the instructions are explained in more detail below.

The data 132 may be retrieved, stored or modified by processor 120 in accordance with the instructions 134. For instance, although the claimed subject matter is not limited by any particular data structure, the data may be stored in computing device registers, in a relational database as a table having a plurality of different fields and records, XML documents or flat files. The data may also be formatted in any computing device-readable format.

The one or more processor 120 may be any conventional processors, such as commercially available CPUs or GPUs. Alternatively, the one or more processors may be a dedicated device such as an ASIC or other hardware-based processor. Although FIG. 1 functionally illustrates the processor, memory, and other elements of computing device 110 as being within the same block, it will be understood by those of ordinary skill in the art that the processor, computing device, or memory may actually include multiple processors, computing devices, or memories that may or may not be stored within the same physical housing. For example, memory may be a hard drive or other storage media located in a housing different from that of computing device 110. Accordingly, references to a processor or computing device will be understood to include references to a collection of processors or computing devices or memories that may or may not operate in parallel.

Computing device 110 may all of the components normally used in connection with a computing device such as the processor and memory described above as well as a user input 150 (e.g., a mouse, keyboard, touch screen and/or microphone) and various electronic displays (e.g., a monitor having a screen or any other electrical device that is operable to display information). In this example, the vehicle includes an internal electronic display 152 as well as one or more speakers 154 to provide information or audio visual experiences. In this regard, internal electronic display 152 may be located within a cabin of vehicle 100 and may be used by computing device 110 to provide information to passengers within the vehicle 100.

Computing device 110 may also include one or more wireless network connections 156 to facilitate communication with other computing devices, such as the client computing devices and server computing devices described in detail below. The wireless network connections may include short range communication protocols such as Bluetooth, Bluetooth low energy (LE), cellular connections, as well as various configurations and protocols including the Internet, World Wide Web, intranets, virtual private networks, wide area networks, local networks, private networks using communication protocols proprietary to one or more companies, Ethernet, WiFi and HTTP, and various combinations of the foregoing.

In one example, computing device 110 may be an autonomous driving computing system incorporated into vehicle 100. The autonomous driving computing system may capable of communicating with various components of the vehicle in order to control the vehicle in an autonomous driving mode. For example, returning to FIG. 1, computing device 110 may be in communication with various systems of vehicle 100, such as deceleration system 160, acceleration system 162, steering system 164, signaling system 166, planner system 168, positioning system 170, and perception system 172 in order to control the movement, speed, etc. of vehicle 100 in accordance with the instructions 134 of memory 130 in the autonomous driving mode. Again, although these systems are shown as external to computing device 110, in actuality, these systems may also be incorporated into computing device 110, again as an autonomous driving computing system for controlling vehicle 100.

As an example, computing device 110 may interact with deceleration system 160 and acceleration system 162 in order to control the speed of the vehicle. Similarly, steering system 164 may be used by computing devices 110 in order to control the direction of vehicle 100. For example, if vehicle 100 is configured for use on a road, such as a car or truck, the steering system may include components to control the angle of wheels to turn the vehicle. Signaling system 166 may be used by computing device 110 in order to signal the vehicle's intent to other drivers or vehicles, for example, by lighting turn signals or brake lights when needed.

Planning system 168 may be used by computing device 110 in order to determine and follow a route to a location. In this regard, the planning system 168 and/or data 132 may store detailed map information, e.g., highly detailed maps identifying the shape and elevation of roadways, lane lines, intersections, crosswalks, speed limits, traffic signals, buildings, signs, real time traffic information, pull over spots, vegetation, or other such objects and information.

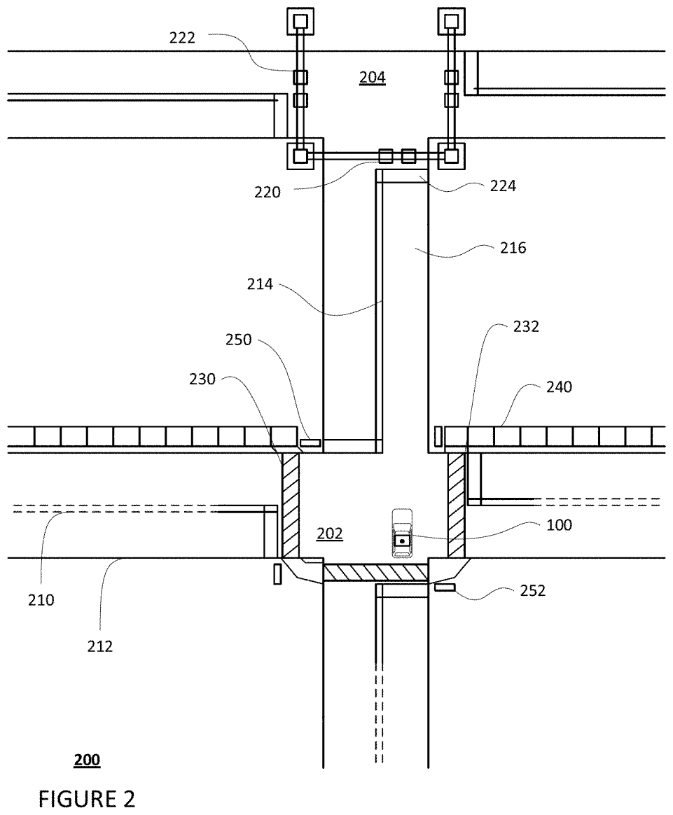

FIG. 2 is an example of map information 200 for a section of roadway including intersections 202 and 204. The map information 200 may be a local version of the map information stored in the memory 130 of the computing devices 110. In this example, the map information 200 includes information identifying the shape, location, and other characteristics of lane lines 210, 212, 214, traffic lights 220, 222, stop line 224, crosswalks 230, 232 sidewalks 240, and traffic signs 250, 252. The map information is depicted herein as an image-based map, the map information need not be entirely image based (for example, raster). For example, the map information may include one or more roadgraphs or graph networks of information such as roads, lanes, intersections, and the connections between these features which may be represented by road segments. Each feature may be stored as graph data and may be associated with information such as a geographic location and whether or not it is linked to other related features, for example, a stop sign may be linked to a road and an intersection, etc. In some examples, the associated data may include grid-based indices of a roadgraph to allow for efficient lookup of certain roadgraph features.

Positioning system 170 may be used by computing device 110 in order to determine the vehicle's relative or absolute position on a map or on the earth. For example, the position system 170 may include a GPS receiver to determine the device's latitude, longitude and/or altitude position. Other location systems such as laser-based localization systems, inertial-aided GPS, or camera-based localization may also be used to identify the location of the vehicle. The location of the vehicle may include an absolute geographical location, such as latitude, longitude, and altitude as well as relative location information, such as location relative to other cars immediately around it which can often be determined with less noise that absolute geographical location.

The positioning system 170 may also include other devices in communication with computing device 110, such as an accelerometer, gyroscope or another direction/speed detection device to determine the direction and speed of the vehicle or changes thereto. By way of example only, an acceleration device may determine its pitch, yaw or roll (or changes thereto) relative to the direction of gravity or a plane perpendicular thereto. The device may also track increases or decreases in speed and the direction of such changes. The device's provision of location and orientation data as set forth herein may be provided automatically to the computing device 110, other computing devices and combinations of the foregoing.

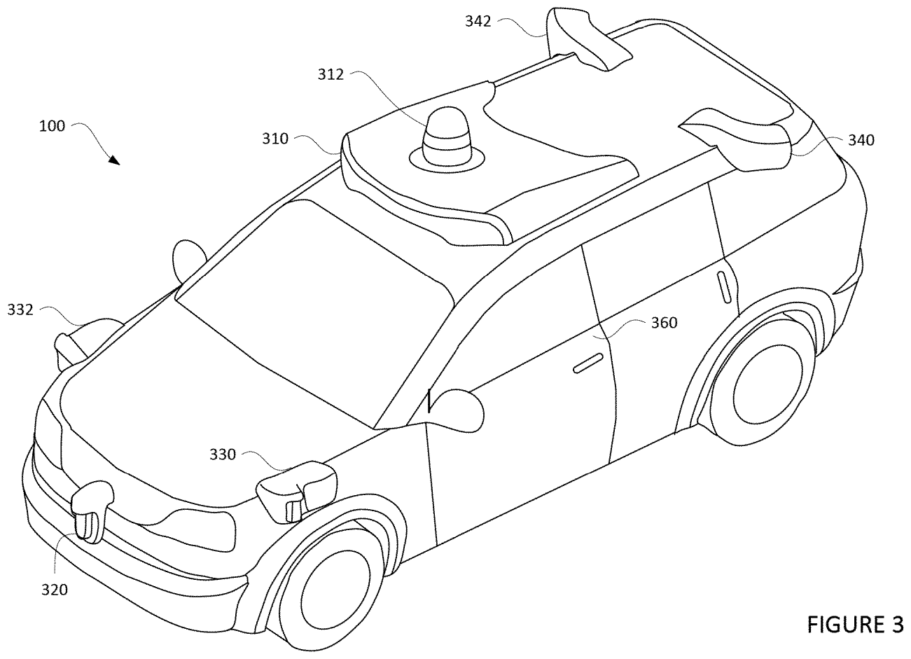

The perception system 172 also includes one or more components for detecting objects external to the vehicle such as other vehicles, obstacles in the roadway, traffic signals, signs, trees, etc. For example, the perception system 172 may include lasers, sonar, radar, cameras and/or any other detection devices that record data which may be processed by computing device 110. In the case where the vehicle is a passenger vehicle such as a minivan, the minivan may include a laser or other sensors mounted on the roof or other convenient location. For instance, FIG. 3 is an example external view of vehicle 100. In this example, roof-top housing 310 and dome housing 312 may include a LIDAR sensor as well as various cameras and radar units. In addition, housing 320 located at the front end of vehicle 100 and housings 330, 332 on the driver's and passenger's sides of the vehicle may each store a LIDAR sensor. For example, housing 330 is located in front of driver door 360. Vehicle 100 also includes housings 340, 342 for radar units and/or cameras also located on the roof of vehicle 100. Additional radar units and cameras (not shown) may be located at the front and rear ends of vehicle 100 and/or on other positions along the roof or roof-top housing 310.

In one example, computing devices 110 may be control computing devices of an autonomous driving computing system or incorporated into vehicle 100. The autonomous driving computing system may capable of communicating with various components of the vehicle in order to control the movement of vehicle 100 according to primary vehicle control code of memory 130. For example, returning to FIG. 1, computing devices 110 may be in communication with various systems of vehicle 100, such as deceleration system 160, acceleration system 162, steering system 164, signaling system 166, planning system 168, positioning system 170, perception system 172, and power system 174 (i.e. the vehicle's engine or motor) in order to control the movement, speed, etc. of vehicle 100 in accordance with the instructions 134 of memory 130. Again, although these systems are shown as external to computing devices 110, in actuality, these systems may also be incorporated into computing devices 110, again as an autonomous driving computing system for controlling vehicle 100.

The various systems of the vehicle may function using autonomous vehicle control software in order to determine how to and to control the vehicle. As an example, a perception system software module of the perception system 172 may use sensor data generated by one or more sensors of an autonomous vehicle, such as cameras, LIDAR sensors, radar units, sonar units, etc., to detect and identify objects and their characteristics. These characteristics may include location, type, heading, orientation, speed, acceleration, change in acceleration, size, shape, etc. In some instances, characteristics may be input into a behavior prediction system software module which uses various behavior models based on object type to output a predicted future behavior for a detected object. In other instances, the characteristics may be put into one or more detection system software modules, such as a traffic light detection system software module configured to detect the states of known traffic signals, construction zone detection system software module configured to detect construction zones from sensor data generated by the one or more sensors of the vehicle as well as an emergency vehicle detection system configured to detect emergency vehicles from sensor data generated by sensors of the vehicle. Each of these detection system software modules may uses various models to output a likelihood of a construction zone or an object being an emergency vehicle. Detected objects, predicted future behaviors, various likelihoods from detection system software modules, the map information identifying the vehicle's environment, position information from the positioning system 170 identifying the location and orientation of the vehicle, a destination for the vehicle as well as feedback from various other systems of the vehicle may be input into a planner system software module of the planning system 168. The planning system and/or computing devices 110 may use this input to generate a route and trajectories for the vehicle to follow for some brief period of time into the future. A control system software module of the computing devices 110 may be configured to control movement of the vehicle, for instance by controlling braking, acceleration and steering of the vehicle, in order to follow a trajectory.

The computing device 110 may control the vehicle by controlling various components. For instance, by way of example, computing device 110 may navigate the vehicle to a destination location completely autonomously using data from the detailed map information and planning system 168. Computing device 110 may use the positioning system 170 to determine the vehicle's location and perception system 172 to detect and respond to objects when needed to reach the location safely. Again, in order to do so, computing device 110 may generate trajectories and cause the vehicle to follow these trajectories, for instance, by causing the vehicle to accelerate (e.g., by supplying fuel or other energy to the engine or power system 174 by acceleration system 162), decelerate (e.g., by decreasing the fuel supplied to the engine or power system 174, changing gears, and/or by applying brakes by deceleration system 160), change direction (e.g., by turning the front or rear wheels of vehicle 100 by steering system 164), and signal such changes (e.g., by lighting turn signals of signaling system 166). Thus, the acceleration system 162 and deceleration system 160 may be a part of a drivetrain that includes various components between an engine of the vehicle and the wheels of the vehicle. Again, by controlling these systems, computing device 110 may also control the drivetrain of the vehicle in order to maneuver the vehicle autonomously.

### Example Methods

In addition to the operations described above and illustrated in the figures, various operations will now be described. It should be understood that the following operations do not have to be performed in the precise order described below. Rather, various steps can be handled in a different order or simultaneously, and steps may also be added or omitted.

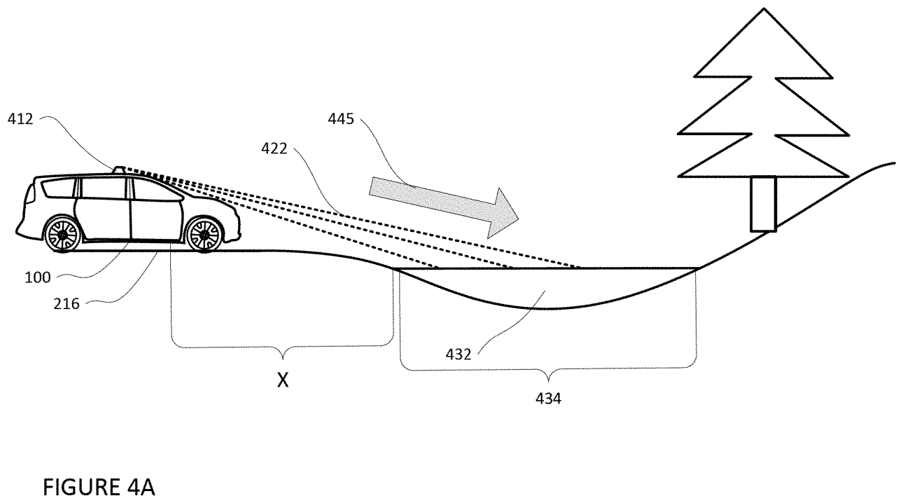

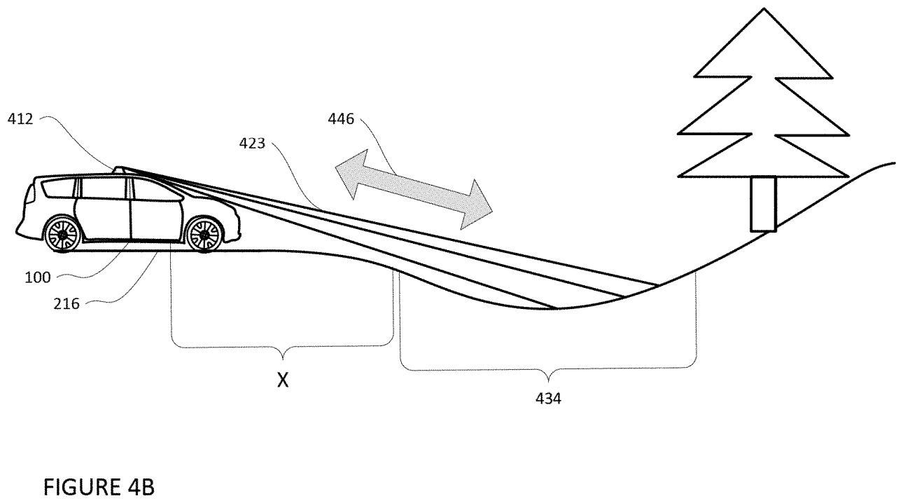

A computing device of an autonomous vehicle, such as computing device 110 of vehicle 100, may analyze sensor data received from the perception system 172 to detect standing water. In this regard, a LIDAR sensor may transmit signals and receive back signals that are reflected off of objects in the vehicle's vicinity. Based on the received signals, the LIDAR may determine whether objects such as trees, other vehicles, road surfaces, etc., are in the vehicle's vicinity, as well as their respective distances from the vehicle. Transmitted LIDAR signals that contact standing water may fail to reflect back to the sensor when the standing water is more than a certain distance from the sensor, such as 10 m, or more or less. Accordingly, the LIDAR sensor may produce little or no sensor data (based on received back LIDAR signals) for locations where standing water is present when the sensor is more than the certain distance from the standing water. For example, and as illustrated in FIG. 4A, when the LIDAR sensor 412 of autonomous vehicle 100 is more than a certain distance from standing water, such as distance ‘X’, the LIDAR signals (illustrated by dashed lines 422) transmitted by the LIDAR sensor 412 may not be reflected back from the standing water 432. In other words, the LIDAR signals 422 travel away from the LIDAR sensor 412, as illustrated by arrow 445, but are not received back from the standing water 432, as the signal may be scattered by the standing water, rather than reflected back. As such, the sensor data produced based on received LIDAR signals by the LIDAR sensor may include little, if any data corresponding to the location 434 of the standing water 432. In contrast, and as illustrated in FIG. 4B, in instances when no standing water 432 is present at location 434 and the LIDAR sensor 412 of the autonomous vehicle 100 is the certain distance ‘X’ from the location 434, LIDAR signals (illustrated as solid lines 423) may be transmitted and received back by the LIDAR sensor 412, as illustrated by double-sided arrow 446. As such, the sensor data produced based on received LIDAR signals 423 by the LIDAR sensor 412 (received sensor data) may include data corresponding to the location 434.

The received sensor data may be compared by the computing devices 110 to map information in order to determine whether a road surface is mapped at the location where no sensor data is received. In this regard, for locations where the amount of sensor data, specifically LIDAR sensor data, is below a threshold value, or for all locations having little to no corresponding sensor data, the computing device 110 may overlay the received sensor data on map information, such as map information 200, corresponding to the location of where no or little sensor data was received. In this regard, the threshold value may correspond to a number of LIDAR sensor data points provided in the sensor data for some given area or volume of space at or proximate to the expected location of a road surface for a given distance from the vehicle. In some instances, the threshold value may be based on the map information. In this regard, the map information may include the reflectivity (i.e., the intensity of signal return) for each portion of a roadway surface as it was mapped. The threshold value may be a certain level of reflectivity at or near the reflectivity captured when the roadway surface was mapped. In other words, the threshold value may vary depending on the portion of the roadway surface to which the received sensor data corresponds.

The computing device 110 may determine that standing water is present in a location where no sensor data is present if the map information indicates a road surface is mapped at the location where no or little sensor data is present. For instance, map information 200 indicates a roadway 216 is present at the location of the standing water 432. As such, the computing device may determine the lack of sensor data is indicative of standing water 432 covering a portion of roadway 216 with a particular confidence value.

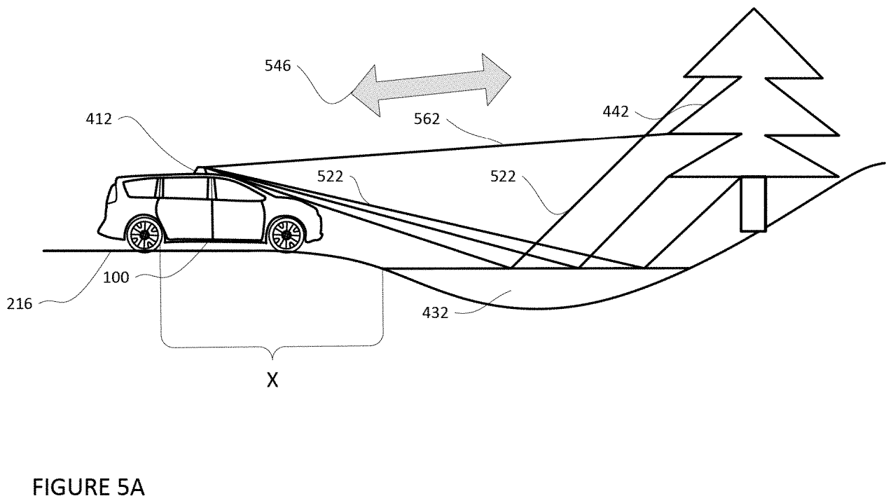

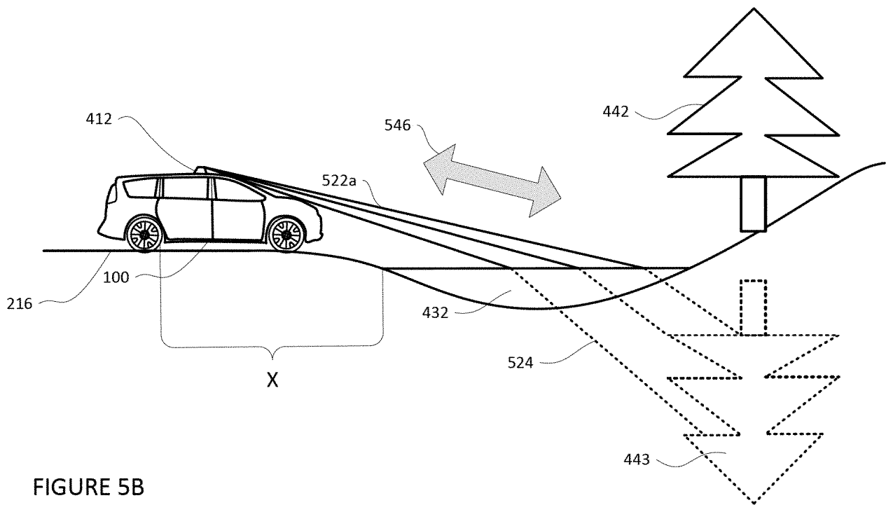

Confidence in the determination that standing water is present may be increased, for instance, when the sensor data includes signals from vertical reflections. In this regard, as the vehicle 100 travels towards the location where standing water was detected, the computing device 110 may monitor the sensor data for vertical reflections (i.e., signals reflected from the surface of the standing water and off of other objects). For instance, as shown in FIG. 5A, when the LIDAR sensor 412 is within the certain distance “X”, LIDAR signals (illustrated as solid lines 522 and 562) may be transmitted and received back by the LIDAR sensor 412, as illustrated by double-sided arrow 546. In this regard, LIDAR signal 562 may be transmitted by the LIDAR sensor 412 and reflected back to the LIDAR sensor after reflecting off of tree 442. Signals 522, which are transmitted by the LIDAR sensor, may reflect off of the standing water 432 and then off of the tree 442. After reflecting off of the tree 442, the signals 522 may reverse direction and again bounce off of the standing water 432 and be received back by the LIDAR sensor 412.

The LIDAR sensor 412 may not be able to determine that the received sensor data is the result of signals 522 reflected off of the surface of the standing water 432 and the tree 442. Rather, the received sensor data may indicate that the received signals 522, including the received data corresponding to the tree 442, are coming from below the standing water. For instance, and as shown in FIG. 5B, the first portion of signals 522, labeled as 522a, may appear to the LIDAR sensor 412 to continue traveling through the standing water 432, as illustrated by broken lines 524 as opposed to reflecting off the surface of the standing water 432, as actually occurs and as illustrated in FIG. 5A. Accordingly, the LIDAR sensor 412 and/or computing device 110 may believe the signals received back are a combination of 522a and 524 being transmitted and reflected off of a tree located below the standing water 432, as indicated by the tree shown in dashed lines 443. The direction of signals 522a and 524 being transmitted and reflected back, as determined by the LIDAR sensor or some processor, is illustrated by double-sided arrow 546.

To determine whether the received LIDAR signals are vertical reflections, the computing device 110 may compare the received sensor data to data received from other sensors, such as camera images. In this regard, the computing device 110 may invert the received sensor data, which indicates the received LIDAR signals are coming from below the standing water 424 (e.g., signals 522a and 524 of FIG. 5B). The inverted sensor data may be overlaid on one or more camera images to determine whether the inverted sensor data aligns with one or more objects captured in the camera images. In the event the sensor data aligns with an object or objects in the camera images, the confidence value in a determination of standing water at the location may be increased. For instance, if the inverted sensor data including data corresponding to tree 443 corresponds to the tree 442 captured in the one or more camera images, the confidence value may be increased. Upon the confidence value in the determination of standing water satisfying a threshold value, the vehicle may make take an action as described further below.

In some instances, received LIDAR sensor data corresponding to one portion of an image may be compared to received sensor data corresponding to another portion of the image. In this regard, the inverted sensor data may be overlaid on sensor data 562 corresponding to data received from a different sensor signal, such as another signal from the LIDAR sensor 412, as further shown in FIG. 5. If the data in the inverted sensor data and the sensor data 562 align, the computing device 110 may determine standing water is present at the location with a particular confidence value. In instances where sensor data from multiple sensors alights with the inverted sensor data, the confidence value may be increased.

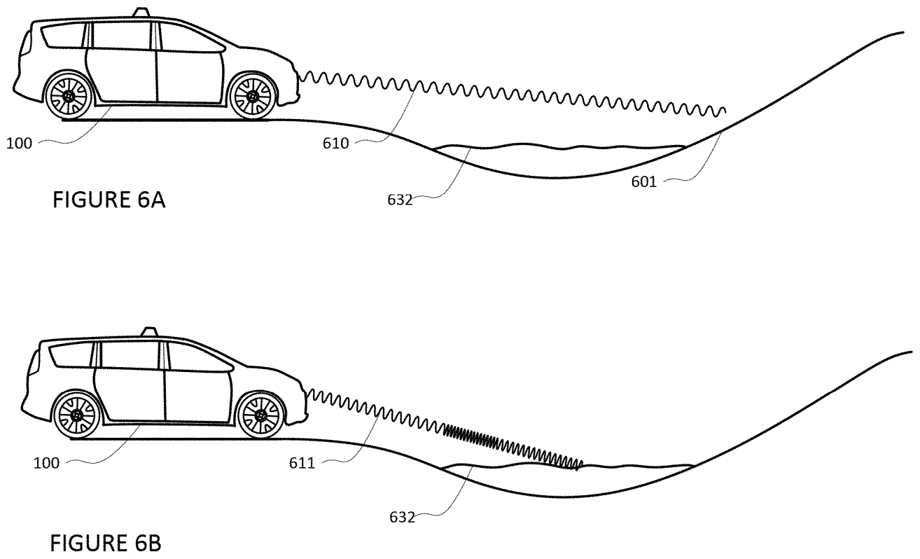

In some instances, radar signals may be used by the computing device to detect standing water. For instance, a surface of standing water may likely be in motion as the result of vibrations and wind, while road surfaces are typically stationary. Accordingly, road surfaces, such as the road surface of road 601 as shown in FIG. 6A, reflect back radar signals 610 with a consistent frequency. In contrast, and as illustrated in FIG. 6B, radar signal 611 reflected off of the surface of standing water, such as the surface of standing water 632, will have varying frequencies indicative of a Doppler effect caused by the movement of the surface of the water. As such, the one or more computing devices of the autonomous vehicle, such as computing device 110 of autonomous vehicle 100 may determine standing water is present on road surfaces where a radar sensor receives signals indicative of a Doppler effect. In some instances, the detection of standing water using radar signals may be used to further increase the confidence value in the determination of standing water.

The dimensions, for instance length and width, as well as an approximation of area, of the standing water may be determined by the computing device 110 from the received LIDAR signals and map information. In this regard, and as described herein, LIDAR signals may not be received at locations where standing water is present. Accordingly, the one or more computing devices 110 may calculate the distance between received signals reflected from locations immediately around the standing water to determine the length and width of the standing water. In this regard, the distance between the points on opposite sides of the standing water may be measured to determine the dimensions, for instance length and width, of the standing water

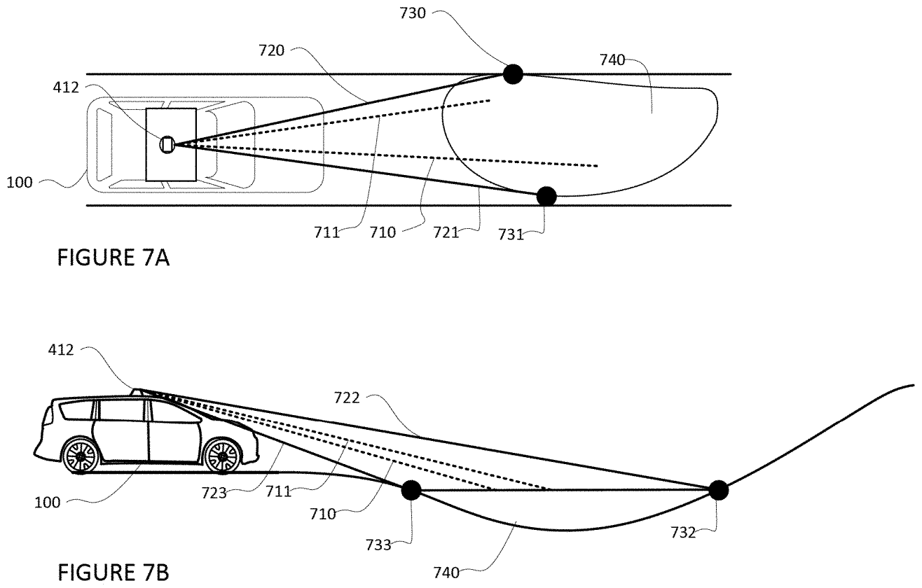

For instance, and as shown in the above and side views of vehicle 100 approaching standing water 740 in FIGS. 7A and 7B, LIDAR signals 710 and 711 may not be received back by the LIDAR sensor 412. The broken lines used to illustrate signals 710 and 711 indicate the signals are transmitted but not received back by the LIDAR sensor 412. However, signals 720, 721, 722, and 723, which reflect back from the location immediately around the standing water 740 may be received by the LIDAR sensor 412, as further illustrated in FIGS. 7A and 7B. The solid lines used to illustrate signals 720, 721, 722, and 723 indicate the signals are transmitted and received back by the LIDAR sensor 412

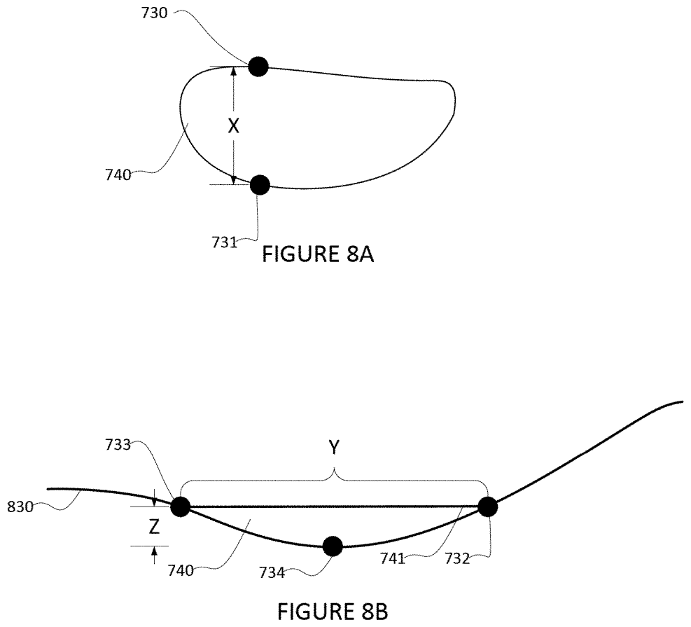

The distance between the locations where received signals 720, 721, 722, and 723 reflected, illustrated as points 730, 731, 732, and 733, respectively, may be determined to determine the length and/or width of the standing water. For instance, and as illustrated in FIG. 8A, the distance between points 730 and 731, located on opposite sides of standing water 740, may be determined to indicate the width (labeled as “X”) of the standing water 740. Points 732 and 733 may correspond to the furthest locations immediately around the standing water on opposite side. The distance between points 732 and 733, located on opposite sides of standing water 740, may be determined to indicate the length (labeled as “Y”) of the standing water 740. An approximation of the area of the standing water may be determined by multiplying the length of the standing water by the width.

The depth of the standing water may be determined by the computing device 110 by comparing received signal locations around the standing water with map information indicating the height of the lowest road surface within the standing water. For instance, and as illustrated in FIG. 8B, the surface 741 of standing water 740 forms a substantially straight line relative to the ground 830. As such, the one or more computing devices, such as computing device 110, may retrieve the height of a road surface, such as from the map data, at the location where the received LIDAR signals indicate the standing water starts and ends (e.g., points 732 and 733). The computing device 110 may then retrieve the lowest point of the road surface between the starting and end points, illustrated as point 734 in FIG. 8B from the map information. The height of the lowest point may then be subtracted from the height of the road surface at the starting point 733 or end point 732 to determine the depth of the standing water, as indicated by depth “Z” in FIG. 8B.

In some instances, the length, width, and/or depth of the water may be determined once the confidence value in the determination of standing water satisfies a threshold value. By doing such, the actions taking by the autonomous vehicle in response to the detection of standing water may be further refined, as described herein.

In addition or alternatively, a machine learning model may be used to determine whether an image captured by the vehicle's camera sensors includes standing water. The model may include a classifier such as a neural network, a deep neural network, decision tree, boosting tree, etc. Generation of the machine learning model may include training the model to identify standing water. Training the machine learning model may include retrieving training data including images of standing water. The training data for the model may be generated from the set of images in various ways. For instance, human operators may label the location of standing water in images by reviewing the images and drawing bounding boxes around the standing water. In addition or alternatively, existing models or image processing techniques may be used to label the location of standing water based on characteristics of standing water such as color, contrast, brightness, texture, etc. LIDAR signals, audio signals, and other such sensor data may also be used as training data. In some instances, the model may first be trained “offline” that is, ahead of time and/or at a remote computing device and thereafter sent and implemented at the vehicle.

Given an image of a roadway including standing water, which may be considered a training input, and labels indicating standing water and the location of the standing water, which may be considered training outputs, the model may be trained to detect standing water and output the location of standing water found in a captured image. As an example, the model may receive the image of a roadway and the model may also receive a label indicating the location of standing water within the image. In other words, the training input and training output are used to train the model on what input it will be getting and what output it is to generate. Based on this training data, the model may learn to identify standing water and its location. In this regard, the training may increase the precision of the model such that the more training data (input and output) used to train the model, the greater the precision of the model at identifying standing water and the location of the standing water.

Once the model is trained, it may be sent or otherwise loaded into the memory of a computing system of a vehicle for use, such as memory 130 of computing device 110 in vehicle 100. For instance, as a vehicle, such as vehicle 100 drives around, the vehicle's perception system 172 may capture sensor data of its surroundings. This sensor data, including any images may be periodically input into the model. The model may then provide a corresponding location for standing water if present in the image. The model may be used along or in conjunction with the other techniques described herein of determining whether standing water is present in the trajectory of the autonomous vehicle. The machine learning model may be used as a standalone system for detecting standing water or in connection with one or more of the other methods herein. Moreover, an output by the machine learning model that standing water is present may increase the confidence value that standing water is present. In some instances, the machine learning model may also be trained to output the dimensions (i.e., length and width) of the standing water.

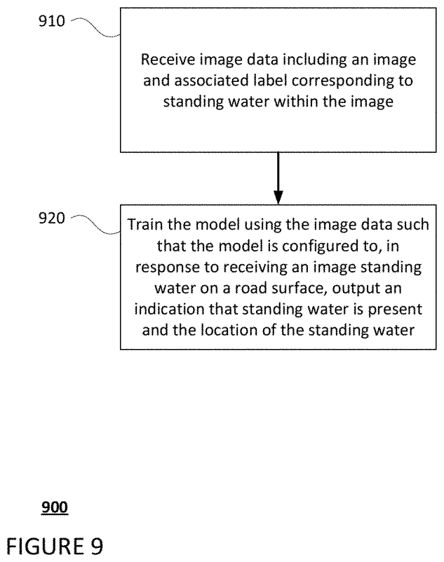

FIG. 9 is an example flow diagram 900 in accordance with aspects of the disclosure which may be performed by one or more processors of one or more computing devices, such as processors 120 of computing devices 110, in order to train a machine learning model to detect standing water. At block 910 image data including an image and associated label(s) corresponding to standing water within the image is received. The model may be trained using the image data such that the model is configured to, in response to receiving an image standing water on a road surface, output an indication that standing water is present and the location of the standing water, as shown in block 920.

Upon a confidence value being provided and satisfying a threshold confidence value, the vehicle, such as vehicle 100 may make take an action to respond to the standing water determined to be present on the surface of a roadway in the trajectory of the vehicle. For instance, the one or more computing devices 110 may automatically reduce the speed of the vehicle as it approaches standing water. Depending on the characteristics of the standing water (e.g., depth, width, length), the nature of the road being traveled, and other factors, the computing device 110 may alter the trajectory of the autonomous vehicle to go around the standing water or traverse a location of the standing water having a depth which satisfies a threshold value determined to be safe to traverse. In instances where the confidence value fails to satisfy the threshold confidence value or falls into a medium or middle range, the one or more computing devices 110 may instruct the autonomous vehicle 100 to take no action, slow down to capture more data, or perform another precautionary maneuver, such as altering trajectory or coming to a stop.

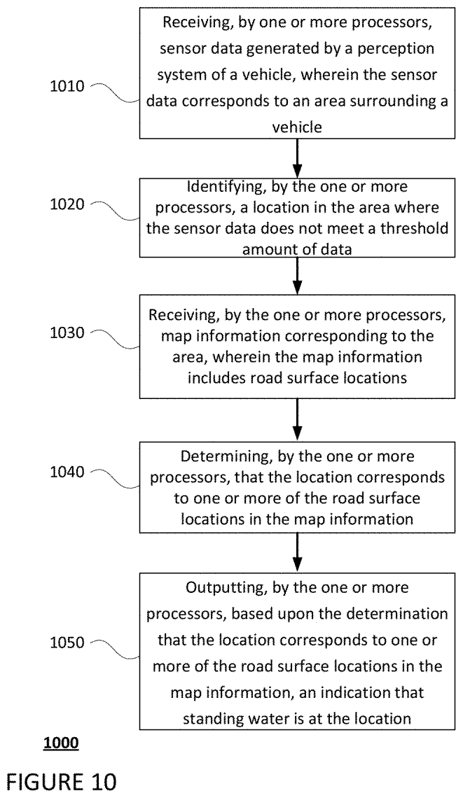

FIG. 10 is an example flow diagram 1000 in accordance with aspects of the disclosure which may be performed by one or more processors of one or more computing devices, such as processors 120 of computing devices 110, in order to detect standing water. At block 1010, sensor data generated by a perception system of a vehicle is received. The sensor data corresponds to an area surrounding a vehicle. A location in the area where the sensor data does not meet a threshold amount of data is identified at block 1020. Map information corresponding to the area is received and the map information includes road surface locations. A determination that the location corresponds to one or more of the road surface locations in the map information is made, as shown in block 1040. Based upon the determination that the location corresponds to one or more of the road surface locations in the map information, an indication that standing water is at the location may be output, as shown in block 1050.

Unless otherwise stated, the foregoing alternative examples are not mutually exclusive, but may be implemented in various combinations to achieve unique advantages. As these and other variations and combinations of the features discussed above can be utilized without departing from the subject matter defined by the claims, the foregoing description of the embodiments should be taken by way of illustration rather than by way of limitation of the subject matter defined by the claims. In addition, the provision of the examples described herein, as well as clauses phrased as “such as,” “including” and the like, should not be interpreted as limiting the subject matter of the claims to the specific examples; rather, the examples are intended to illustrate only one of many possible embodiments. Further, the same reference numbers in different drawings can identify the same or similar elements.

1. A method of detecting standing water, the method comprising:
receiving, by one or more processors, sensor data generated by a perception system of a vehicle, wherein the sensor data corresponds to an area surrounding a vehicle;
identifying, by the one or more processors, a location in the area where the sensor data does not meet a threshold amount of data;
receiving, by the one or more processors, map information corresponding to the area, wherein the map information includes road surface locations;
determining, by the one or more processors, that the location corresponds to one or more of the road surface locations in the map information; and
outputting, by the one or more processors, based upon the determination that the location corresponds to one or more of the road surface locations in the map information, an indication that standing water is at the location.

2. The method of claim 1, wherein the sensor data is generated by a LIDAR sensor.

3. The method of claim 1, wherein identifying the location in the area where the sensor data does not meet the threshold amount includes determining the amount of sensor data in the area is below the threshold amount.

4. The method of claim 1, further comprising identifying a starting point and an end point of the standing water, wherein the starting point and end point correspond to locations where received signals are reflected back from an area immediately around the standing water; and
the starting point is a point nearest to the vehicle and end point is located at an opposite side of the standing water.

5. The method of claim 4, further comprising determining a length of the standing water, wherein the length is determined by calculating the distance between the starting point and end point.

6. The method of claim 1, further comprising identifying a pair of points on opposite sides of the standing water, wherein the pair of points correspond to locations where received signals are reflected back from an area immediately around the standing water.

7. The method of claim 4, further comprising determining a width of the standing water, wherein the width is determined by calculating the distance between the pair of points.

8. The method of claim 4, further comprising:
determining, based on the map information, a lowest elevation point of the road surface at the location;
determining the elevation of the starting point or ending point; and
determining a depth of the standing water by calculating a distance between the lowest elevation point and the elevation of either the starting or the end point.

9. The method of claim 1, further comprising, adjusting the operation of the vehicle based on the indication that standing water is at the location.

10. The method of claim 1, further comprising determining a confidence value of the indication that standing water is at the location; and
adjusting the operation of the vehicle upon the confidence value satisfying a threshold value.

11. The method of claim 1, further comprising:
capturing a camera image, including image data, of the area surrounding a vehicle; and
inputting the image into a model to identify the location of the standing water.

12. The method of claim 11, wherein, upon identifying the location of the standing water by the model, increasing a confidence value; and
adjusting the operation of the vehicle upon the confidence value satisfying a threshold value.

13. A system for detecting standing water, the system comprising:
one or more processors, wherein the one or more processors are configured to:
receive sensor data generated by a perception system of a vehicle, wherein the sensor data corresponds to an area surrounding a vehicle;
identify a location in the area where the sensor data is not present;
receive map information corresponding to the area, wherein the map information includes road surface locations;
determine that the location corresponds to one or more of the road surface locations in the map information; and
output, based upon the determination that the location corresponds to one or more of the road surface locations in the map information, an indication that standing water is at the location.

14. The system of claim 13, further comprising the vehicle.

15. The system of claim 13, wherein the sensor data is generated by a LIDAR sensor of the perception system.

16. The system of claim 13, wherein the one or more processors are further configured to identify a starting point and an end point of the standing water, wherein the starting point and end point correspond to locations where received signals are reflected back from an area immediately around the standing water; and
the starting point and end point are located on opposite sides of the standing water.

17. The system of claim 16, wherein the one or more processors are further configured to determine the length of the standing water, wherein the length is determined by calculating the distance between the starting point and end point.

18. The system of claim 13, wherein the one or more processors are further configured to identify a pair of points on opposite sides of the standing water, wherein the pair of points correspond to locations where received signals are reflected back from an area immediately around the standing water.

19. The system of claim 18, wherein the one or more processors are further configured to determine the width of the standing water, wherein the width is determined by calculating the distance between the pair of points.

20. The system of claim 18 further comprising the vehicle.
